(19) United States
(12) Patent Application Publication
(10) Pub. No.: US 2026/0091983 A1
(43) Pub. Date: Apr. 2, 2026

(54) USE OF ZINC IN SYNTHESIS OF LARGE-MESOPORE Y ZEOLITE

(71) Applicants: CHEVRON U.S.A. INC., SAN RAMON, CA (US); THE REGENTS OF THE UNIVERSITY OF CALIFORNIA, OAKLAND, CA (US)

(72) Inventors: Alexander KATZ, Richmond, CA (US); Xuemin LI, Berkeley, CA (US); Jinyi HAN, San Ramon, CA (US); Axel BRAIT, San Rafael, CA (US); Bi-Zeng ZHAN, Albany, CA (US); Howard Steven LACHEEN, Richmond, CA (US); Alexander E. KUPERMAN, Midland, MI (US)

(73) Assignees: CHEVRON U.S.A. INC., SAN RAMON, CA (US); THE REGENTS OF THE UNIVERSITY OF CALIFORNIA, OAKLAND, CA (US)

(21) Appl. No.: 19/220,338

(22) Filed: May 28, 2025

Related U.S. Application Data
(60) Provisional application No. 63/701,147, filed on Sep. 30, 2024.

(51) Int. Cl. C01B 39/24

(52) U.S. Cl. CPC C01B 39/24; C01P 2002/72; C01P 2002/85; C01P 2004/03; C01P 2004/04; C01P 2006/14; C01P 2006/16

(57) ABSTRACT

Provided is a process for synthesizing mesopores-Y zeolite having mesopores up to about 20 nm in diameter. The process comprises starting with a parent meso-Y zeolite and imposing intimate contact between a zinc species and aluminosilicate of the meso-Y zeolite while calcining. The calcined product is then subjected to a hydrothermal treatment in the presence of a residual amount of the Zn species. The species can comprise ZnO.

### CROSS REFERENCE TO RELATED APPLICATIONS

The present application claims priority to U.S. Provisional Application No. 63/701,147, filed Sep. 30, 2024, the complete disclosure of which is incorporated herein by reference in its entirety.

### BACKGROUND

### Field of the Disclosure

The present disclosure relates to preparation of mesopore Y zeolites. More specifically, the use of zinc in the preparation of large mesopore Y zeolites.

### Description of the Related Art

Microporous zeolites (pore size<2 nm) are crystalline aluminosilicates that are constructed from corner-sharing [SiO₄]⁻ and [AlO₄]⁻ tetrahedra linked by oxygen bridges. Due to their high degree of shape selectivity and hydrothermal stability, zeolites have been applied in various industrial processes. However, mass-transport limitations imposed by zeolite micropores make accessibility for sterically bulky molecules challenging, and motivate synthetic approaches for introducing hierarchical mesopores into zeolites. To this end, tremendous efforts have been made for hierarchical zeolite synthesis and two main approaches, e.g., top-down and bottom-up approaches, have been widely investigated. The former approach includes steaming, chemical treatment (acid, alkaline, ethylenediaminetetraacetic acid (EDTA), etc.), and recrystallization and the latter includes soft sacrificial templates (surfactant, polymers and organ silanes) as well as ones based on hard materials (carbon-based and inorganics).

Y zeolite (FAU type) has been one the most widely applied zeolite catalysts in industrial processes in the petroleum and petrochemical industry, as well as emerging applications such as polymer upcycling, with significant progress being achieved for the synthesis of mesoporous Y zeolites. An approach was developed for mesoporous Y zeolite synthesis consisting of alkaline treatment of ultra stable Y (USY) zeolites in the presence of metal salts (e.g., Mg²⁺, Al³⁺, Cu²⁺, Fe²⁺, and Zn²⁺) followed by acid treatment. Their resulting materials exhibit a mesopore volume of up to 0.5 cm³/g. Another approach for mesoporous Y zeolites describes a simple sequential treatment of commercial USY zeolites with a chelating acid (H₄EDTA or Na₂H₂EDTA) and alkali (NaOH), resulting in up to 0.52 cm³/g of mesopore volume. A separate approach involves surfactant-templating (top-down approach) relying on trimethyl alkylammonium bromide as the surfactant under basic conditions, which imparts up to 5.3 nm mesopores within USY zeolites. A supramolecular approach complementary to the surfactant templating strategy has been reported where swelling agents were added to the synthetic solution, to further expand the mesopore size (up to 6.8 nm using C₁₈TAB with the addition of 1,3,5-trimethylbenenze).

However, none of the above-mentioned reports synthesized mesoporous Y material with a pore size larger than 10 nm. There are a few of such reports. One reported the synthesis of large mesoporous Y zeolite with a pore size centered at 18 nm with the silane monomer N,N-dimethyl-N-octadecyl-N-(3-triethoxysilylpropyl) ammonium bromide ([(C₂H₅O)₃SiC₃H₆N(CH₃)₂C₁₈H₃₇]Br) as a mesoscale template. Another applied sacrificial carbon aerogel as the hard template and successfully synthesized 10.0 nm mesoporous Y zeolite. Both of these two studies applied a bottom-up approach, and templates that required additional synthesis steps. By using post-treatment approaches, one reported treatment of commercial USY with NaOH to obtain bimodal mesopores having a diameter of 3.0 nm (main mesopores) and 30.0 nm (secondary mesopores). Another reported the synthesis of 10.0 nm mesopores in Y zeolite with sequential treatments involving aqueous solutions of H₄EDTA, NaOH, and Na₂H₂EDTA. In addition, a NaOH treatment of USY in the presence of Pluronic P-123 (P123) surfactant and diethylamine (DEA) resulted in mesopores having a diameter of 13.0 nm and 12.0 nm, respectively, though low yields were reported. Another reported the synthesis of mesopores ranging from 10-20 nm upon treating USY zeolites in water at 200° C. for 6 h, resulting in low mesopore volumes (<0.37 cm³/g). More recently there was reported the synthesis of mesoporous Y materials (up to 16.0 nm) by hydrothermally treating a USY zeolite in a 0.37 M aqueous NH₃ solution at 150° C. for 10 h. The high degree of crystallinity retention of the mesoporous Y zeolites in this last report is unexpected in view of the observed loss of crystallinity of other Y zeolites under similar conditions involving NH₄OH and/or hot water.

Zn species are also reported to affect the physicochemical properties of the resultant zeolites. ZnO addition during the organic-free FAU-type zeolite synthesis has been reported to increase the Si/Al ratio up to 3. When Zn species were incorporated into the zeolite framework, it was demonstrated to stabilize Zn-FAU against undergoing an interzeolite transformation, while Zn addition during synthesis resulted in the synthesis of a mesoporous variant of zeolite X with a layer-like morphology (FAU-type). This approach was also reported to increase the ion-exchange capacity (MFI-type) and Lewis acidity (MOR-type), and shifted the mesopore size distribution to larger diameters within the 1-5 nm range (MFI-type). ZnO has been used as a hard template for mesoporous MFI zeolite synthesis through a bottom-up strategy, resulting in a pore-size distribution of 10.0 nm after calcination. Reports have also detailed the role of Zn species in zeolitic material delamination, where ZnO nanoparticles were proposed to grow and force layers apart to facilitate delamination.

A more effective and efficient synthesis process for layer mesopore Y zeolites would be of value and greatly welcome in the catalyst industry.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure encompass a variety of aspects that may not be set forth below.

Provided is a method of synthesizing materials based on mesoporous Y (Meso-Y) zeolites that have mesopores up to 20 nm in diameter, and generally a mesopore volume of above 0.64 cm³/g. The synthesis involves starting with conventional Meso-Y zeolites and imposing intimate contact between a zinc species such as ZnO and aluminosilicate via initial calcination. The synthesis involves the formation of a dense zincoaluminosilicate (ZnAlSi) phase during the calcination step. During a subsequent hydrothermal treatment, the ZnAlSi phase rearranges along with the synthesis of large mesopores up to 20 nm in diameter. Residual zinc species must be present during the subsequent hydrothermal treatment in order to achieve a synthesis of large mesopores. The mesopore Y zeolite obtained has been observed to have larger mesopores and mesopore volumes, lower micropore volumes, and milder Bronsted acidity.

Among other factors, the addition of a zinc species such as ZnO followed by a hydrothermal treatment has been found to be an effective approach for synthesizing large mesopores in meso-Y-zeolites. The synthesis relies on (i) intimate contact between a Zn species and aluminosilicate in a calcination, (ii) a residual amount of the Zn species during a hydrothermal treatment, and (iii) preservation of the zeolite framework during the hydrothermal treatment.

### BRIEF DESCRIPTION OF THE DRAWINGS

FIG. 1A depicts nitrogen physisorption/desorption isotherms at 77 K.

FIG. 1B depicts DFT pore-size distributions based on the data in FIG. 1A.

FIG. 1C shows PXRD patterns of the materials before and after hydrothermal treatment, as well as the parent CBV 720 and conventional Mo—Y material synthesized without ZnO addition (OZnO—Y—C).

Stacked isotherms, pore-size distributions and PXRD patterns in FIGS. 1A-1C are offset for visual clarity. The amount of offset is indicated on the left for all the patterns.

FIG. 2A depicts nitrogen physisorption/desorption isotherms at 77 K.

FIG. 2B depicts DFT pore-size distributions based on the data in FIG. 2A.

FIG. 2C graphically shows the cumulative pore volume of mesopores having a local maximum in the pore-size distribution of 16 nm or higher as a function of the initial HNO₃ concentration used in acid treatment just prior to hydrothermal treatment with the resulting solution.

FIG. 2D shows PXRD patterns of materials synthesized using different acid concentrations: the HNO₃ concentrations from the bottom to top are 0.00 M (30ZnO—Y—C-135HT0.00-C); 0.5 M (30ZnO—Y—C-135HT0.05-C); 0.10 M (30ZnO—Y—C-135HT0.10-C); 0.13 M (30ZnO—Y—C-135HT0.13-C); 0.15(30ZnO—Y—C-135HT0.15-C); 0.17 M (30ZnO—Y—C-135HT0.17-C); 0.20 M (30ZnO—Y—C-135HT0.20-C); and 0.30 (30ZnO—Y—C-135HT0.30-C).

Stacked isotherms, pore-size distributions and PXRD patterns are offset for visual clarity in FIGS. 2A-2D. The amount of offset of isotherms and pore-size distributions, and PXRD patterns are indicated on the right and left, respectively.

FIG. 3A depicts nitrogen physisorption/desorption isotherms at 77 K.

FIG. 3B depicts DFT pore-size distributions.

FIG. 3C shows PXRD patterns of materials synthesized with various ZnO content from the bottom to the top using water alone (0.00 M HNO₃): 0.0 wt. % ZnO (0ZnO—Y—C-135HT0.00-C); 1.0 wt. % ZnO (1ZnO—Y—C-135HT0.00-C); 2.5 wt. % ZnO (2.5ZnO—Y—C-135HT0.00-C); 5.0 wt. % ZnO (5ZnO—Y—C-135HT0.00-C); 10.0 wt. % ZnO (10ZnO—Y—C-135HT0.00-C); 15.0 wt. % ZnO (15ZnO—Y—C-135HT0.00-C); and 30.0 wt. % ZnO (30ZnO—Y—C-135HT0.00-C).

Stacked isotherms, pore-sized distributions, and PXRD patterns are offset for visual clarity in FIGS. 3A-3C. The amount of offset of isotherms and pore-size distributions, and PXRD patterns are indicated on the right and left, respectively.

FIG. 4A shows PXRD patterns of materials synthesized by delaying the addition of ZnO (and C₁₆TAB) before hydrothermal treatment.

FIG. 4B shows PXRD patterns after hydrothermal treatment.

FIG. 4C depicts nitrogen physisorption/desorption isotherms at 77 K.

FIG. 4D depicts DFT pore-size distributions of materials after hydrothermal treatment.

Stacked isotherms and pore-size distributions are offset for visual clarity in FIGS. 4A-4D. The amount of offset of isotherms and pore-size distributions are indicated on the right for all the patterns.

FIG. 5A shows SEM image at a length scale of 100 nm of 30ZnO—Y—C.

FIG. 5B shows SEM image at a length scale of 100 nm of 30ZnO—Y—C.

FIG. 5C shows SEM image at a length scale of 100 nm of 30ZnO—Y—C-135HT01.5-C.

FIG. 5D shows SEM image at a length scale of 100 nm of 30ZnO—Y—C-135HT01.5-C.

FIG. 5E shows SEM image at a length scale of 100 nm of 0ZnO—Y—C-135HT01.5-C.

FIG. 5F shows SEM image at a length scale of 100 nm of parent (CBV720).

FIG. 6A shows HAADF-STEM image at different length scale of 30ZnO—Y—C-135HT0.15-C.

FIG. 6B shows HAADF-STEM image at different length scale of 30ZnO—Y—C-135HT0.15-C.

FIG. 6C shows HAADF-STEM image at different length scale of 30ZnO—Y—C-135HT0.15-C.

FIG. 6D shows the corresponding Si and Zn elemental map of FIG. 6C.

FIG. 6E shows SEM images of 30ZN—O—Y—C-135HT 0.15-C at a length scale of 100 nm.

FIG. 7A shows SEM-EDX elemental analysis of 30ZnO—Y—C (average Zn composition is 4.6 wt. % and 42.3 wt. % in Zn-poor and Zn-rich region, respectively).

FIG. 7B shows SEM-EDX elemental analysis of 30ZnO—Y—C-135HT0.15-C (average Zn composition is 2.2 wt. %).

FIG. 8A shows an SEM image of 9.3ZnO (Zn alkoxide)-Y—C at length scale of 500 nm.

FIG. 8B shows an SEM image of 9.3ZnO (Zn alkoxide)-Y—C at length scale of 2 μm.

FIG. 8C shows an SEM image of 9.3ZnO (Zn alkoxide)-Y—C-100HT 0.00-C at a length scale of 500 nm.

FIG. 8D shows an SEM image of 9.3ZnO (Zn alkoxide)-Y—C-100HT 0.00-C at a length scale of 2 μm.

### DETAILED DESCRIPTION

Before the mesoporous Y zeolites and the processes for preparing them are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present process relates to a large mesoporous Y material synthesis, which combines the surfactant-templating approach and the addition of a Zn species. The present approach relies on an amount of Zn species being present during hydrothermal treatment of the material, where there is a Zn redistribution throughout as well as the synthesis of larger mesopores, which are evident after calcination. Synthesizing these larger mesopore is driven by the synthesis of a dense zincoaluminosilicate (ZnAlSi) phase. This approach can function in concert with the templating action of C₁₆TAB under basic conditions.

In general, the process comprises providing a parent meso-Y-zeolite, which zeolite can be a conventional meso-Y-zeolite. In one embodiment, the meso-Y-zeolite has been or is treated with a surfactant, as is known. The surfactant can be any suitable surfactant, but is preferably a cetyltrimethylammonium (CTA) surfactant. In one embodiment, the CTA is a bromide (CTAB) surfactant.

The meso-Y-zeolite is then calcined together with a zinc species, which is zinc precursor. The zinc species can comprise ZnO, a zinc alkoxide or a zinc salt. The zinc salt can be an acid salt such as zinc nitrate. The amount of zinc species combined together with the meso-Y-zeolite can be any suitable amount. In one embodiment, the amount of zinc species can range from about 20 to 40 wt. % based on the weight of the zeolite. In one embodiment, the amount is about 30 wt % zinc species.

The calcination is conducted under conventional calcination conditions. The temperature can range from about 500 to 600° C. in one embodiment and can be about 500° C. in one embodiment. The calcination is conducted until a material with a zincoaluminosilicate phase is produced. This phase is generally quite dense and comprises a large amount of the available zinc. The length of time can generally range from about 3-7 hours, and in one embodiment is about 5 hours. The length of time is somewhat dependent on the temperature of the calcination.

Subsequent to the calcination, the material with the zincoaluminosilicate phase is subjected to a hydrothermal treatment. This treatment first and foremost must be conducted in the presence of residual zinc species. It is important that residual zinc species is part of the hydrothermal treatment. The amount of residual zinc species remaining will depend on the amount of zinc species used in the calcination, and the severity of the calcination. Generally, the remaining residual zinc species or zinc precursor can range from 1 to about 25 wt % of the material comprising the zincoaluminosilicate phase. In one embodiment, the amount of residual zinc species can range from about 5 to about 20 wt % or, in another embodiment, from about 7 to about 12 wt % of the material comprising the zincoaluminosilicate phase.

The hydrothermal treatment is essentially an aqueous acid wash with heat. The aqueous acid solution used can have a varied acid concentration, as is suitable. Generally, the acid concentration in the solution used ranges from about 0.05 M to about 0.30 M. In one embodiment, the acid concentration can range from about 0.10 M to about 0.30 M, or from about 0.15 M to about 0.20 M in another embodiment. In one embodiment, the acid concentration ranges from about 0.17 M to about 0.20 M. The treatment is run at a temperature of about 100° C. to 190° C. In one embodiment, the temperature of the hydrothermal treatment can range from about 135 to 175° C. The length of the treatment is generally about 15 to about 18 hours, for example, about 16 hours in one embodiment.

It is during the hydrothermal treatment that the dense zincoaluminosilicate phase rearranges to synthesize the large mesopores. The mesopores can range up to 20 nm, or even larger, in diameter. Generally, the mesopores are in the range of from about 9 to about 16 nm in diameter. The overall mesopore volume of the product meso-Y zeolite is generally from about 0.45 to about 0.70 cm³/g. Often the mesopore volume can be above 0.64 cm³/g.

The large mesopores have been found to be even more enhanced by a final acid wash of the recovered large mesopore meso-Y zeolites. The acid wash can be with an aqueous nitric acid or hydrochloric acid solution, or any suitable acid solution. An aqueous nitric acid solution is preferred. It is believed that the wash may remove any residual zinc, and thereby even further enlarge the large mesopores.

A schematic exemplary approach for synthesis of large Meso-Y material using ZnO as the zine species precursor, is shown below:

The present examples are produced to further illustrate the present zeolites and methods of preparation. The examples are illustrative and are not meant to be limiting.

### Experimental Methods

### Materials

Hexadecyltrimethylammonium bromide (C₁₆TAB, Sigma-Aldrich, >99%) sodium hydroxide (Pellets, Neta Scientific Inc), parent Y zeolite CBV720 (ZE0290, Si/Al=15, Zeolyst), ZnO (Tayca MZ-500 uncoated ZnO, 25 nm primary particle size, the surface area of 45 m²/g; Tayca MZ-300 uncoated ZnO, 35 nm primary particle size, the surface area of 30 m²/g; Evercare Zano 20 uncoated ZnO, the surface area of 36 m²/g), Zn(NO₃)₂·6H₂O (Sigma-Aldrich, 98%), HNO₃ (Fisher Scientific, 68.0 to 70.0% (w/w)), diethylzinc solution (Sigma-Aldrich, 15 wt. % in toluene), and 2-ethoxyethanol (Sigma-Aldrich, 99%) were used as received. The water used in all experiments reported was deionized.

### Material Characterization

N₂ physisorption isotherms, powder X-ray diffraction (PXRD) patterns, and scanning electronic microscopy (SEM) images were measured using conventional procedures and devices. In detail, N₂ physisorption isotherms were measured at 77 Kon a Micromeritics ASAP2020 adsorption instrument. The material was degassed at 350° C. for 4 h under vacuum before analysis. The micropore volume, micropore surface area, and external surface area were measured by the t-plot method. OFT pore-size distributions were calculated from the adsorption branch, and the mesopore volume was calculated from the adsorption branch using the Barrett-Joyner-Halenda (BJH) method. Powder X-Ray diffraction (PXRD) patterns were collected on a Rigaku Mini Flex diffractometer using a Cu Ka radiation (40 kV, 15 mA) ranging from 5 to 50° with a step size of 0.01°. SEM was performed with a Zeiss Crossbeam 550 scanning electron microscope operated at 1 kV and 5.0 mm working distance. The elemental composition of the synthesized materials was determined by ICP at Galbraith Laboratories.

SEM-Energy-Dispersive X-ray spectroscopy (EDX) characterization was conducted with JEOL JSM 6700F fitted with an Oxford Instruments UltimMax 100 mm detector.

High-angle annular dark-field scanning transmission electron microscopy (HAADF-STEM) images were collected on a Talos F200X instrument operating at 200 kV accelerating voltage with a field emission gun. STEM-EDX spectroscopy and elemental mapping were collected with the same Talos instrument equipped with a SuperX Energy Dispersive Spectrometry system with four Silicon Drift Detectors with a solid angle of 0.9 srad. Images were captured using a 4 k×4 k Cata 16 M CMOS camera.

### Example 1

### Synthesis of Large Mesopore Meso-Y Material Using ZnO as the Precursor

0.50 g C16TAB and 20.0 g NaOH solution (0.16 M) were added to a plastic bottle and heated in a 90° C. oil bath for 25 min. Then, 1.0 g CBV720 (ZE0290) and different amounts of ZnO (with a ZnO to zeolite ratio ranging from 0.0% to 30.0%; ZnO type of MZ-500 unless specified) were added to the solution, and the whole solution was stirred for another 6 h. After cooling, the contents were poured into a filter, and the precipitated solids were washed several times with water until neutral. The resultant material was dried in a 60° C. oven overnight followed by 580° C. calcination for 5 h in air before further treatment. The corresponding material was called xZnO—Y—C, where x refers to the ZnO to Y zeolite mass percentage, and C represents the calcination step after washing. Hydrothermal treatment was performed by taking 0.4 g of the calcined (580° C. for 5 h) material and adding it to 14.0 g of 0.00 to 0.30 M HN03 solution in a 20 mL autoclave. The mixture was heated at a temperature of (135-175° C.) for 16 h in a rotary oven (˜20 RPM). The hydrothermally treated material was washed, dried and calcined following the procedures above. The corresponding material was called xZnO—Y—C-yHTz-C, where y is the hydrothermal treatment (HT) temperature in ° C., and z is the HNQ3 solution concentration in mol/L (see Scheme 1). In addition, sample xZnO—Y—C (m h of ZnO)-yHTz-C and xZnO—Y—C (m h of ZnO and C16TAB)-yHTz-C were synthesized following the above procedure except that ZnO (and C₁₆TAB) was added minutes hours (m h) later after the start of synthesis signified by CBV720 addition.

### Example 2

### Synthesis of Large Mesopore Meso-Y Material Using Zn Alkoxide as the Precursor

Postsynthetic Zn alkoxide incorporation into the as-made conventional Meso-Y material (the mass ratio of ZnO to as-made zeolite is 9.3 wt. %) is described below. In a typical synthesis 2.0 g of as-made Meso-Y material is pretreated at 160° C. (or 250° C.) under vacuum for 8 h to remove moisture. Then, the sample is transferred to a new Schlenk flask in an Ar-filled glovebox before introducing 2-ethoxyethanol (15 mL) and bis(2-ethoxyethoxy) zinc solution (prepared in a separate Schlenk flask: 2.1 mL diethylzinc solution (15 wt. % in toluene) was added dropwise to 5.0 mL of 2-ethoxyethanol and stirred for 20 min under air-free conditions.

The mixture was then stirred at room temperature for 5 min followed by sonication (Branson 3510-R-MTH ultrasonic cleaner) for 30 min. The suspension was then evaporated under vacuum in a Schlenk line at room temperature for 12 h to obtain a dry material, before calcination at 580° C. for 5 h. Hydrothermal treatment and the following treatments followed the previous procedure in Example 1 except that water, instead of HNO₃ solution, was used as the hydrothermal treatment solution.

### Example 3

Synthesis of Large Mesopore Meso-Y Material Using Zn(NO₃)₂ as the Precursor

The procedure of Zn species incorporation using Zn(NO₃)₂ as the precursor is similar to the Zn alkoxide incorporation, where the 160° C. vacuum-treated as-made mesoporous Y was used as the zeolite precursor. Instead of conducting Zn incorporation under vacuum conditions, the vacuum-treated as-made mesoporous Y was directly used under ambient conditions. The detailed procedure is as follows: 1.5 mL of the Zn(NO₃)₂ solution (ZnO to as-made zeolite mass ratio of 9.3 wt. %; Zn(NO₃)₂ solution concentration of 0.38 M) was added to the vacuum-treated as-made mesoporous Y precursor (0.403 g, corresponding to 0.5 g as-made zeolite) with subsequent stirring for 15 min manually before drying the sample at 60° C. overnight. Then the sample was calcined at 580° C. for 5 h. The following hydrothermal treatment procedure is the same as in Example 1, except the hydrothermal treatment temperature was 100° C.

### Example 4

### Final Acid Wash

To investigate acidity of the synthesized materials, a final acid treatment after hydrothermal treatment and calcination was conducted as follows: 0.5 g of hydrothermally treated and calcined material was added to 17.5 g of 0.10 M aqueous HNO3 solution in a 20 mL autoclave. The mixture was heated at 100° C. for 16 h in a rotary oven (˜20 rpm). Washing, drying, and calcination procedures were the same as described above. The obtained material was identified by a suffix of “-lO0HT0.10-C” in its name. When HCl was used as the final acid wash reagent, a suffix of “-lO0HT0.lO(HCl)—C” was used instead.

### Results and Discussions Regarding Examples 1-4

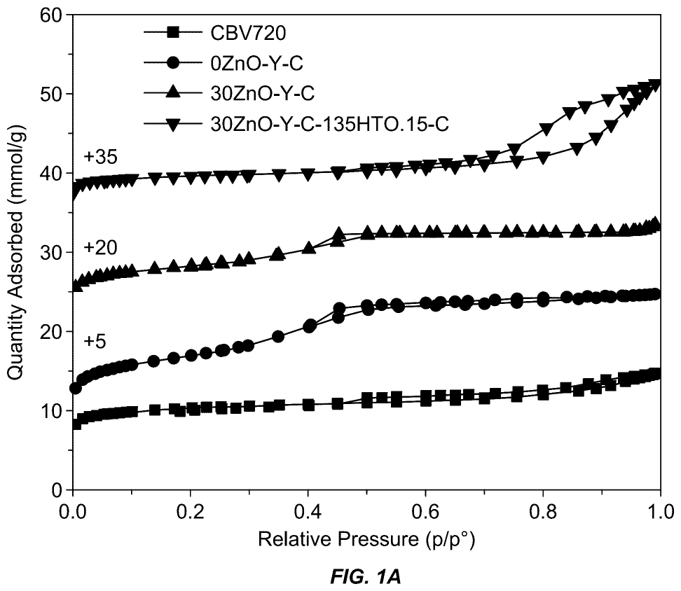

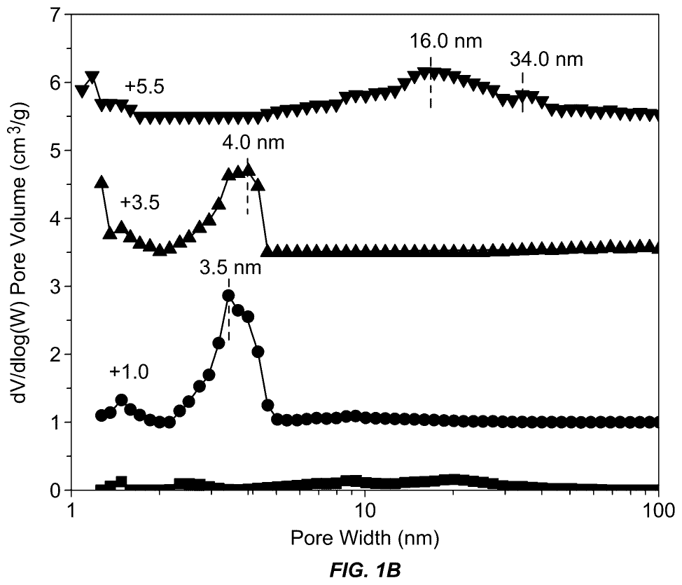

Characterization data of 0ZnO—Y—C in FIGS. 1A-1C demonstrate the reproduced synthesis of conventional Meso-Y from CBV 720. FIGS. 1A and 1B show a 3.5 nm mesopore size as a maximum in the distribution for 0ZnO—Y—C, which is largely absent in the parent CBV720 zeolite, whereas FIG. 1C shows only slightly reduced FAU crystallinity for 0ZnO—Y—C relative to CBV720. Upon adding 30 wt. % ZnO nanoparticles (relative to zeolite weight) to the beginning of the Meso-Y synthesis (i.e. at the stage of CBV 720 zeolite addition) and calcining the resulting material to synthesize 30ZnO—Y—C, data in FIGS. 1A-1C show only a slight increase in mesopore size up to 4.0 nm compared to conventional Meso-Y (0ZnO—Y—C, 3.5 nm).

The simple zinc oxide incorporation into a Meso-Y synthesis followed by calcination is insufficient for synthesizing large (10 nm and higher diameter) mesopores. This is consistent with previous observations of similar syntheses involving ZnO incorporation under basic zeolite Y synthesis condition. Powder X-ray diffraction (PXRD) data of 30ZnO—Y—C in FIG. 1C demonstrate retention of crystallinity as well as evidence of crystalline ZnO. Upon hydrothermally treating 30ZnO—Y—C in 0.15 M aqueous HNO₃ at 135° C. for 16 h and calcining the resulting material, data in FIG. 1B demonstrate the synthesis of 16.0 nm mesopores in 30ZnO—Y—C-135HT0.15-C. Comparing 30ZnO—Y—C-135HT0.15-C and 30ZnO—Y—C, data in Table 1 demonstrate an inverse relationship between the increasing mesopore volume accompanying the synthesis of large mesopores and the decreasing micropore volume after hydrothermal treatment. It appears some of the zeolite was etched to form the larger mesopores, consistent with previously postulated mechanisms for mesopore formation under aqueous basic conditions.

ICP data in Table 1 indicate that the Zn content decreased from 17.4 wt. % in 30ZnO—Y—C (theoretical 18.5 wt. %) to 4.16 wt. % in 30ZnO—Y—C-135HT0.15-C (theoretical 1.7 wt. % assuming the added acid was fully consumed titrating ZnO) after hydrothermal treatment with 0.15 M aqueous MNO₃ solution. Comparing the PXRD data for 30ZnO—Y—C and 30ZnO—Y—C-135HT0.15-C in FIG. 1C, a decrease in zeolite crystallinity for the latter is observed. A decrease is also observed corresponding in bulk ZnO for 30ZnO—Y—C-135HT0.15-C relative to 30ZnO—Y—C in FIG. 1C, indicating acid extraction of crystalline ZnO during the aqueous acidic conditions of hydrothermal treatment and consistent with the decrease of Zn content described above.

TABLE 1
Textural properties of conventional and large-mesopore Meso-Y materials.

| | DFT | | | | | Volume | | | Zn |
|---|---|---|---|---|---|---|---|---|---|
| | pore size | Surface area (m²/g) | | | | (cm³/g) | | Si/Al | content^{f} |
| Sample | (nm) | S_{BET}^{a} | S_{micro}^{b} | Sₑₓₜₑᵣₙₐₗ^{c} | V^{total} | V_{micro}^{d} | Vₘₑₛₒ^{e} | ratio^{f} | (wt. %) |
| CBV720 | — | 869 | 636 | 233 | 0.50 | 0.26 | 0.24 | 15 | 0 |
| 0ZnO-Y-C | 3.5 | 968 | 348 | 620 | 0.74 | 0.15 | 0.59 | 12.3 | 0 |
| 30ZnO-Y-C | 4.0 | 668 | 274 | 395 | 0.50 | 0.11 | 0.39 | 12.7 | 17.4 |
| 30ZnO-Y-C- | 16 | 378 | 215 | 162 | 0.54 | 0.09 | 0.45 | 12.7 | 4.16 |
| 135HT0.15-C | | | | | | | | | |

^{a}S_{BET} = BET surface area (total surface area);
^{b}S_{micro} = micropore surface area, t-plot method;
^{c}Sₑₓₜₑᵣₙₐₗ = external surface area, t-plot method;
^{d}V_{micro} = micropore volume, t-plot;
^{e}Vₘₑₛₒ = mesopore volume, BJH method from adsorption;
^{f}Data from ICP test, except the Si/Al ratio of CBV720, which is the nominal value from Zeolyst

### Example 5

The essential role of ZnO for the synthesis of large mesopores was investigated by performing hydrothermal treatment on a Meso-Y control material, which altogether lacked ZnO addition, while keeping all other synthesis steps the same. The resulting material after hydrothermal treatment and calcination, 0ZnO—Y—C-135HT0.10-C, entirely lacks mesopores larger than 5.0 nm in the pore-size distribution. A nearly full loss of crystallinity is observed via PXRD for 0ZnO—Y—C-135HT0.10-C, which is in contrast to the significant amount of retained crystallinity following hydrothermal treatment and calcination for the material synthesized in the presence of ZnO (30ZnO—Y—C-135HT0.10-C). To more fully understand this, a variant of the material without ZnO was synthesized, which involved hydrothermal treatment in water, rather than aqueous acid solution, followed by calcination. This latter material, 0ZnO—Y—C-135HT0.00-C, exhibited a mesopore size of 6.3 nm and a significant amount of retained crystallinity. (See Table 3 below.)

These data support a reported conclusion that hydrothermal treatment itself produces some mesopores, but not the large 16.0 nm ones synthesized here with ZnO. Crystallinity loss is correlated with the pH of hydrothermal treatment, which accounts for why 0ZnO—Y—C-135HT0.10-C lacking ZnO leads to the most severe crystallinity loss, since there is no ZnO to neutralize the aqueous acid. The observed loss of zeolite crystallinity is associated with the dealumination of the zeolite framework under acidic hydrothermal conditions. The results above emphasize the necessity of both zinc species and hydrothermal treatment for the synthesis of large 16.0 nm mesopores in 30ZnO—Y—C-135HT0.10-C.

### Example 6

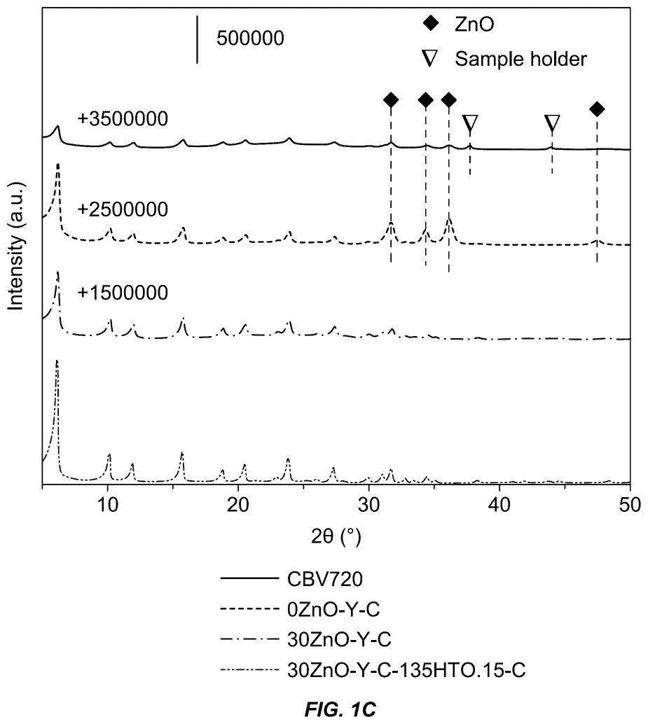

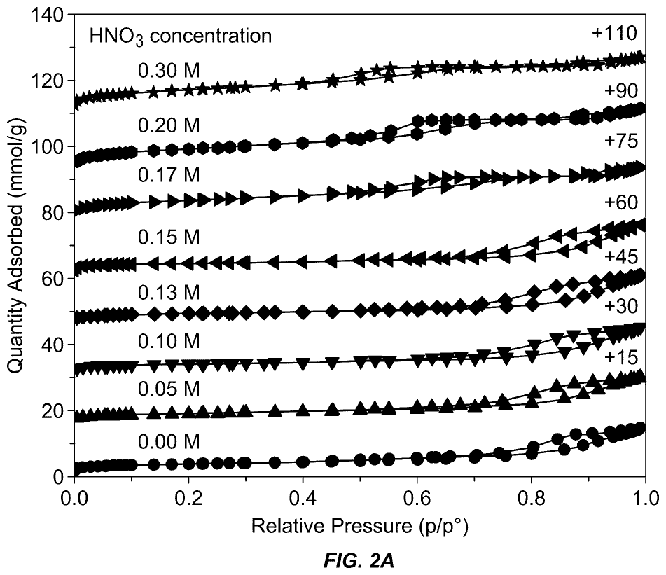

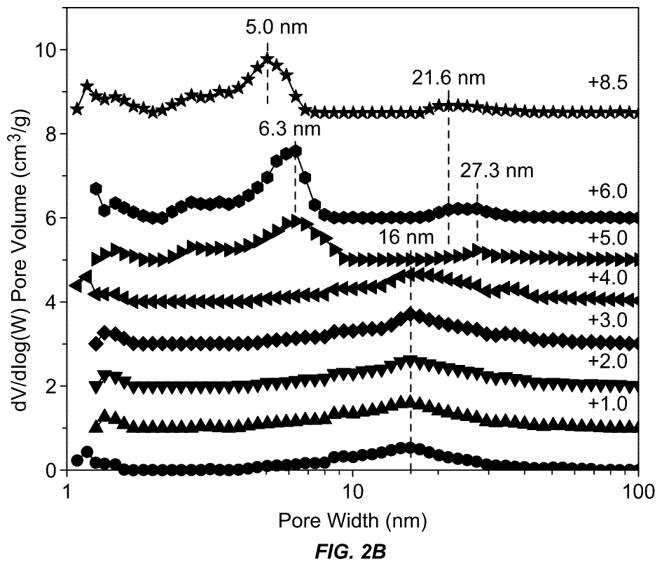

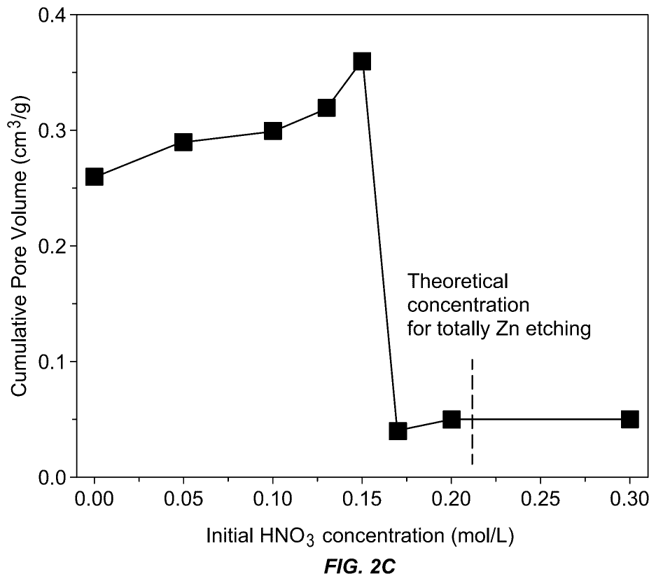

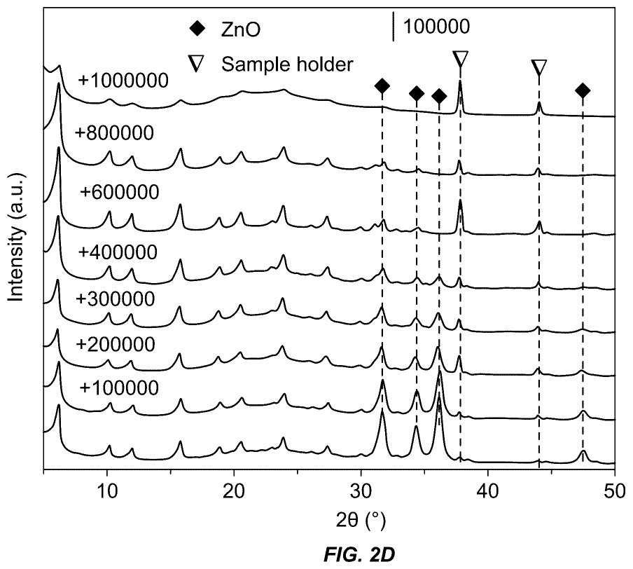

To investigate the effect of acid concentration on mesoporosity, different aqueous HNO₃ concentrations for hydrothermal treatment (0.00 M, 0.05 M, 0.10 M, 0.13 M, 0.15 M, 0.17 M, 0.20 M, and 0.30 M) where studied, thereby defacto controlling the unneutralized ZnO content during hydrothermal treatment—during which the large mesopores are synthesized. Data in FIGS. 2A and 2B show that for syntheses involving acid concentrations lower than 0.15 M, materials containing large mesopores with a broad distribution centered at 16.0 nm were synthesized. The cumulative pore volume (pore volume of mesopores having a local maximum of 16.0 nm or higher in the pore-size distribution) data in FIG. 2C show that the synthesis of the largest mesopores (i.e. those over 16.0 nm) slightly increases in the acid concentration range of 0.00 M to 0.15 M. Data in Table 2 below show that the total mesopore volume exhibits a maximum of 0.49 cm³/g at an acid concentration of 0.13 M HNO₃. This is in stark contrast to materials resulting from syntheses with acid concentrations in the 0.17 M to 0.30 M concentration range, which resulted mainly in much smaller mesopores around 5.0 nm-6.3 nm in diameter, with only a small minority of large mesopores. Although these latter large mesopores were centered at pore sizes above 20 nm in the distribution at these higher acid concentrations, their amounts were relatively small, according to the pore-size distribution and cumulative pore volume data in FIGS. 2B and 2C. PXRD data in FIG. 2D demonstrate an amorphous hump at 15.0° to 30.0° 20 for all materials synthesized in the acid concentration range of 0.00 M to 0.30 M, which we interpret below. At slightly higher acid concentrations corresponding to 0.17 M-0.2 M, when there is below critical threshold ZnO remaining for the synthesis of large mesopores during hydrothermal treatment, slightly more crystallinity compared to those in the HNO₃ range of 0.00-0.15 M is retained. This is in contrast to the simple HNO₃ concentration dependence we observed above, when relating crystallinity loss to the HNO₃ concentration of hydrothermal treatment, for materials lacking ZnO addition (0ZnO—Y—C-135HT0.10-C, vide supra). When the acid concentration increased to 0.30 M, there was a large amount of excess acid during hydrothermal treatment, and this led to a dramatic decrease in the zeolite crystallinity in FIG. 2D.

The observed final pH values after hydrothermal treatment demonstrate a correlation with the synthesis of large mesopores (16.0 nm diameter in pore-size distribution). In particular, those pH values above 5.5 correlate with the synthesis of large mesopores and indicate the presence of residual ZnO in the synthesis during hydrothermal treatment, as a result of insufficient acid added. On the other extreme, a final pH value below 3.6 indicates depletion of a critical amount of ZnO, which results in the complete lack of large mesopores. This regime corresponds with the observed sharp cutoff in large-mesopore synthesis above a hydrothermal-treatment acid concentration of 0.17 M in FIGS. 2A and 2B. A threshold amount of ZnO is required during hydrothermal treatment and the corresponding amount of acid is only slightly less than the amount calculated for complete dissolution of ZnO, which is 0.21 M. These data suggest that the synthesis of large 16.0 nm mesopores requires a reservoir of unneutralized ZnO during hydrothermal treatment.

If the role of ZnO is simply that of a sacrificial spacer—a porogen (i.e. synthesis of large-scale mesoporosity in place of a ZnO particle occupying the same volume and acting as a template for large mesopore synthesis), one would expect to observe a gradual decrease in the synthesis of large mesopores, as ZnO was dissolved during hydrothermal treatment in increasing levels, in syntheses with greater acid concentration (i.e. lower pH). This decrease would be expected to correlate directly to the disappearance of the porogen. Instead, the sharp, highly nonlinear dependence of large-mesopore synthesis with HNO₃ concentration in FIG. 2C demonstrates a more complex process, albeit one that crucially relies on ZnO for the synthesis of large 16.0 nm mesopores. In addition, the pore-size independence on ZnO sources and dependence on the hydrothermal treatment temperatures also support that ZnO is not simply a sacrificial spacer.

TABLE 2
Textural properties of Meso-Y materials synthesized
using various HNO₃ acid concentrations during hydrothermal
treatment at a ZnO to zeolite ratio of 30%.

| | DFT | | | | | | |
|---|---|---|---|---|---|---|---|
| | Pore | | | | | | |
| | size | Surface area (m²/g) | | | Volume (cm³/g) | | |
| Sample | (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} |
| 30ZnO-Y-C-135HT0.00-C | 16.0 | 311 | 125 | 186 | 0.48 | 0.05 | 0.43 |
| 30ZnO-Y-C-135HT0.05-C | 16.0 | 323 | 134 | 187 | 0.53 | 0.05 | 0.48 |
| 30ZnO-Y-C-135HT0.10-C | 16.0 | 325 | 155 | 170 | 0.53 | 0.06 | 0.47 |
| 30ZnO-Y-C-135HT0.13-C | 16.0 | 355 | 182 | 173 | 0.56 | 0.07 | 0.49 |
| 30ZnO-Y-C-135HT0.15-C | 16.0 | 378 | 215 | 162 | 0.54 | 0.09 | 0.45 |
| 30ZnO-Y-C-135HT0.17-C | 6.3/27.4 | 699 | 270 | 429 | 0.66 | 0.11 | 0.55 |
| 30ZnO-Y-C-135HT0.20-C | 6.3/27.4 | 735 | 184 | 551 | 0.78 | 0.08 | 0.70 |
| 30ZnO-Y-C-135HT0.30-C | 5.0/21.6 | 532 | 13 | 519 | 0.49 | 0.02 | 0.47 |

^{a}S_{BET} = BET surface area (total surface area);
^{b}S_{micro} = micropore surface area, t-plot method;
^{c}Sₑₓₜₑᵣₙₐₗ = external surface area, t-plot method;
^{d}V_{micro} = micropore volume, t-plot;
^{e}Vₘₑₛₒ = mesopore volume, BJH method from adsorption.

### Example 7

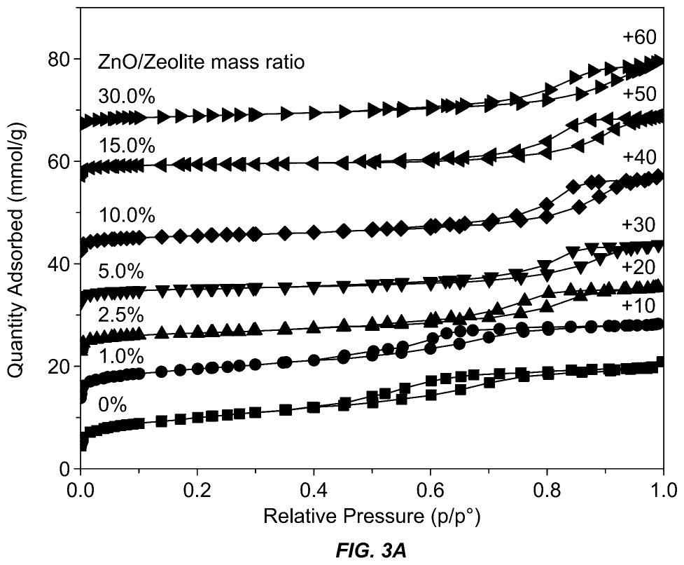

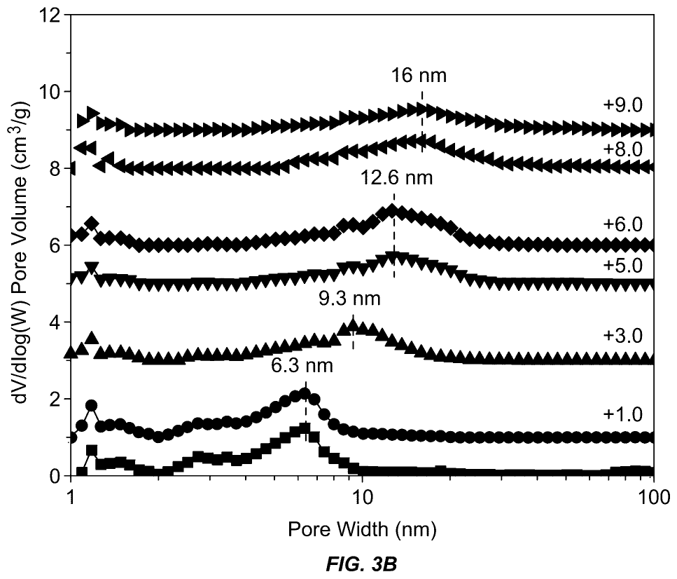

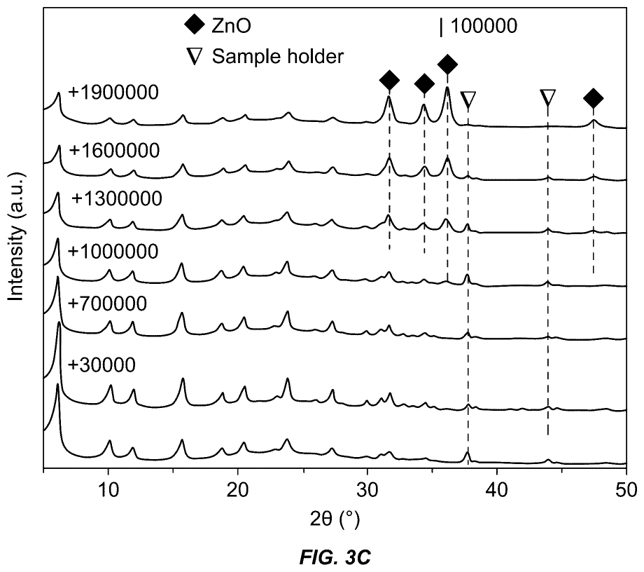

To further investigate the role of ZnO, materials with varying ZnO content (0 wt. %, 1.0 wt. %, 2.5 wt. %, 5 wt. %, 10 wt. %, 15 wt. %, and 30 wt. %, with recorded pH values before and after hydrothermal treatment), were synthesized. The materials were then subjected to the same hydrothermal treatment of 135° C. with water alone, in the absence of added acid. As shown in FIGS. 3A and 3B, when increasing ZnO content from 2.5 wt. % to 30.0 wt. %, the mesopore size distribution increased from 9.3 nm to 16.0 nm, indicating that ZnO content directly correlates with the mesopore size. The data with the presence of three distinct plateaus is summarized in FIG. 3B at the ZnO content ranges of (i) 0.0 wt. % to 1.0 wt. %, (ii) 5.0 wt. % to 10.0 wt. %, and (iii) 15.0 wt. % to 30.0 wt. %. Table 3 below further shows that increasing ZnO content in the range of 0.0 wt. % to 25.0 wt. % decreased the total (BET) surface area, while maintaining a similar micropore volume (around 0.10 cm³/g). At a ZnO content level of 30.0 wt. %, the micropore volume dropped sharply to 0.05 cm³/g. The mesopore volume decreased in the ZnO content range of (i), whereas in the latter two plateau regions (ii and iii, with a corresponding mesopore size distribution of 12.6 nm and 16.0 nm, respectively), increasing ZnO content increases the mesopore volume (see Table 3) while maintaining the same pore-size distribution. Accumulated ZnO content prior to hydrothermal treatment contributes to both mesopore size and mesopore volume.

PXRD patterns in FIG. 3C indicate that increased ZnO content decreased zeolite crystallinity while synthesizing an amorphous phase, following hydrothermal treatment and calcination. When ZnO content was equal to or higher than 5.0 wt. %, bulk ZnO peaks are also apparent after hydrothermal treatment, showing excess residual ZnO in the synthesis. Because this corresponds to a regime where larger mesopores are synthesized, these data further support a critical minimum residual amount of undissolved ZnO being required for the synthesis of large mesopores during hydrothermal treatment. These data also demonstrate ZnO-content control of mesoporosity.

TABLE 3
Textural properties of materials synthesized using different ZnO content.

| | DFT | | | | | | |
|---|---|---|---|---|---|---|---|
| | Pore | | | | | | |
| | size | Surface area (m²/g) | | | Volume (cm³/g) | | |
| Sample | (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} |
| 30ZnO-Y-C-135HT0.00-C | 16 | 311 | 125 | 186 | 0.48 | 0.05 | 0.43 |
| 15ZnO-Y-C-135HT0.00-C | 16 | 372 | 266 | 106 | 0.47 | 0.11 | 0.36 |
| 10ZnO-Y-C-135HT0.00-C | 12.6 | 446 | 226 | 219 | 0.55 | 0.09 | 0.46 |
| 5ZnO-Y-C-135HT0.00-C | 12.6 | 418 | 239 | 178 | 0.45 | 0.10 | 0.35 |
| 2.5ZnO-Y-C-135HT0.00-C | 9.3 | 527 | 258 | 269 | 0.49 | 0.11 | 0.38 |
| 1ZnO-Y-C-135HT0.00-C | 6.3 | 749 | 262 | 487 | 0.51 | 0.11 | 0.42 |
| 0ZnO-Y-C-135HT0.00-C | 6.3 | 776 | 206 | 570 | 0.61 | 0.09 | 0.52 |

^{a}S_{BET} = BET surface area (total surface area);
^{b}S_{micro} = micropore surface area, t-plot method;
^{c}Sₑₓₜₑᵣₙₐₗ = external surface area, t-plot method;
^{d}V_{micro} = micropore volume, t-plot;
^{e}Vₘₑₛₒ = mesopore volume, BJH method from adsorption.

### Example 8

To understand the essential role of calcination before hydrothermal treatment, the hydrothermal treatment of materials without prior calcination was compared with materials that underwent calcination. Materials hydrothermally treated without this prior calcination step resulted in a lack of large 16.0 nm mesopores. There is a bonding that occurs between aluminosilicate species and ZnO during the calcination step that precedes hydrothermal treatment and this bonding is essential for the synthesis of large mesopores during the hydrothermal treatment. This bonding is believed to involve the condensation of ZnO to aluminosilicate, facilitating the formation of a dense ZnAlSi phase (no added porosity evident for 30ZnO—Y—C), which is the active phase for large mesopore formation during hydrothermal treatment.

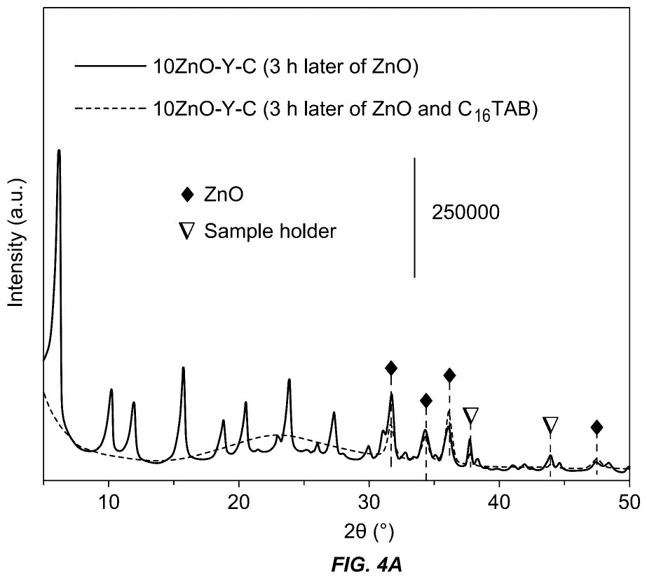

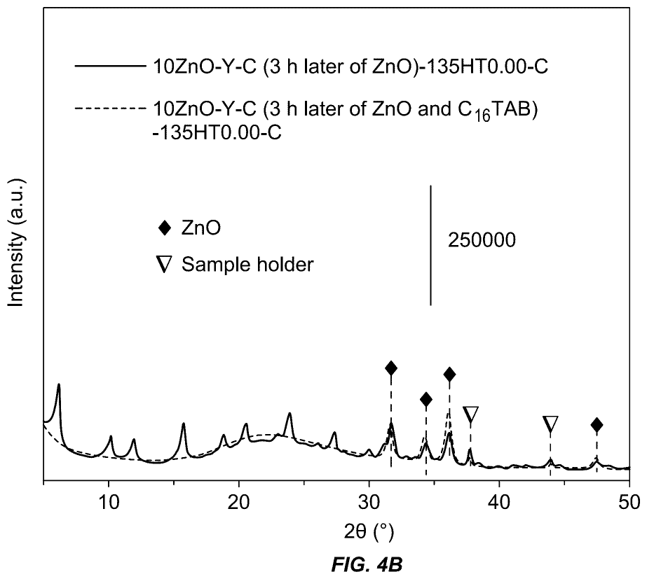

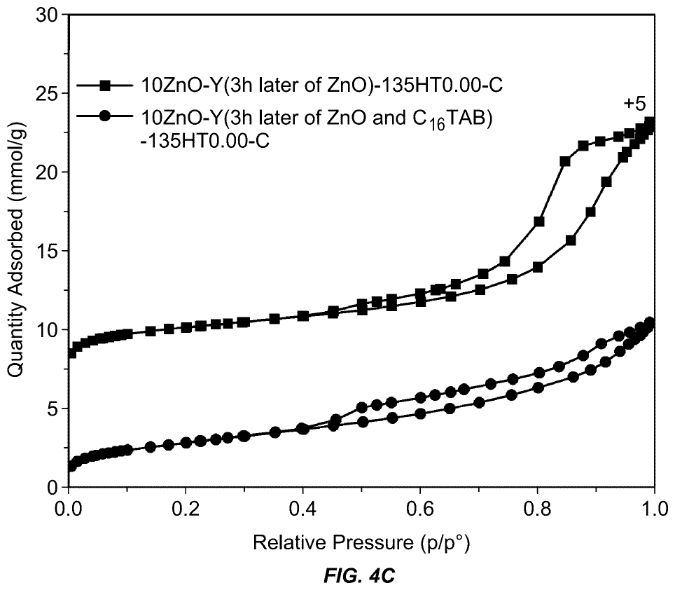

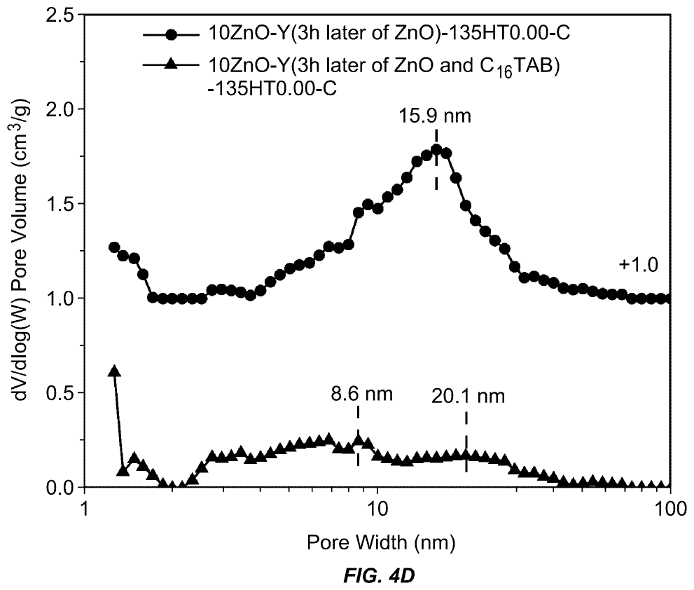

When delaying the addition of ZnO to 3 h after starting the synthesis of Meso-Y instead of immediate addition at the beginning, a shift in the pore-size distribution to larger pore sizes and a larger mesopore volume with a slight decrease in crystallinity was observed. Further delaying the addition of C₁₆TAB for 3 h (e.g., adding both C₁₆TAB and ZnO 3 h later than the parent zeolite), during the synthesis led to the total dissolution of zeolite, both before and after hydrothermal treatment, whereas delaying the addition of ZnO only (e.g., adding C₁₆TAB together with CBV 720) preserved the zeolite crystallinity. This is shown in FIGS. 4A and 4B. C₁₆TAB apparently protects the zeolite framework from dissolving in the presence of NaOH.

Physisorption data in FIGS. 4C-4D indicate that delaying the addition of both ZnO and C₁₆TAB (10ZnO—Y—C (3 h later of ZnO and C₁₆TAB)-135HT0.00-C) resulted in a broad mesopore distribution with around half of the mesopore volume of 10ZnO—Y—C (3 h later of ZnO)-135HT0.00-C. Preserving the zeolite framework before hydrothermal treatment via the protection afforded by C₁₆TAB surfactant is important for the synthesis of large mesopores. In other words, the data above demonstrate that the present approach is not general in the sense of working from an amorphous silica and alumina source.

In summary, the addition of ZnO followed by hydrothermal treatment was demonstrated to be an effective approach for synthesizing large mesopores in Meso-Y zeolites, and relies on (i) intimate contact between ZnO and aluminosilicate via initial calcination, (ii) critical residual amount of ZnO during hydrothermal treatment, and (iii) preservation of the zeolite framework during subsequent hydrothermal treatment. It seems etching of the zeolite during hydrothermal treatment by residual ZnO as a reagent is involved, which explains the synthesis of large mesopores (9.3 to 16.0 nm) at the expense of loss of microporosity and zeolite crystallinity. The driving force for this zeolite etching by ZnO is thermodynamic in nature and involves the formation of a dense ZnAlSi material. This is believed to be the first demonstration of synthesizing a substantial pore volume of large (16.0 nm) mesopores in Y zeolite.

### Example 9

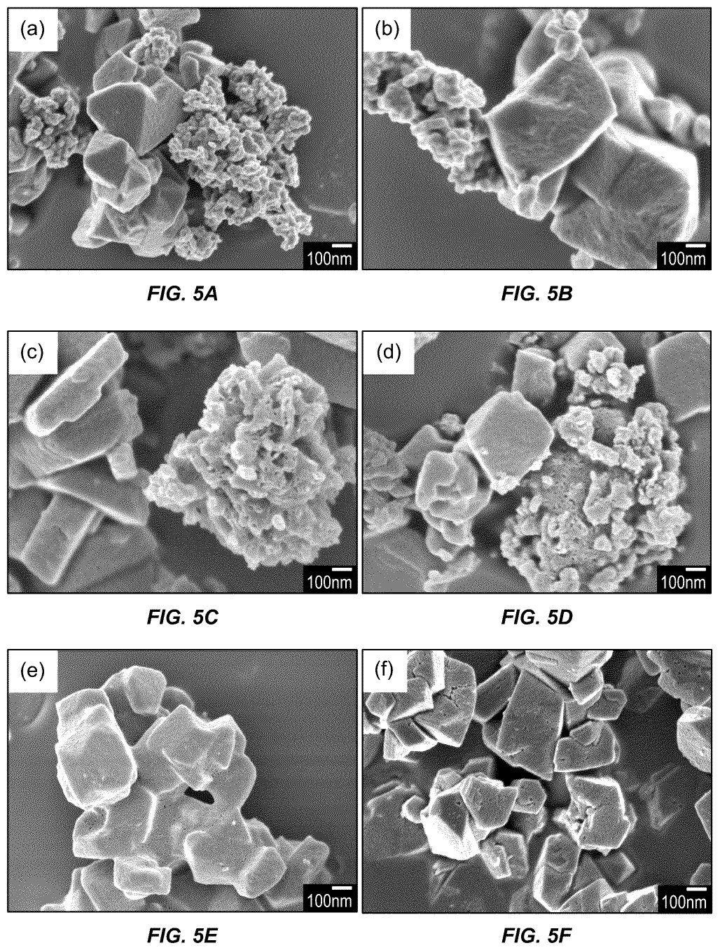

The evolution of the synthesis of 16.0 nm mesopores in 30ZnO—Y—C-135HT0.15-C—an optimal material synthesized with 30 wt. % ZnO relative to zeolite and consisting of 16.0 nm mesopores with a mesopore volume of 0.45 cm³/g, was investigated. Scanning electron microscopy (SEM) images of materials before hydrothermal treatment (30ZnO—Y—C) in FIGS. 5A-5B and after hydrothermal treatment (30ZnO—Y—C-135HT0.15-C) in FIGS. 5C and 5D clearly show two different morphologies: one phase represents the crystalline zeolite, and the other a non-zeolitic phase, whereas the non-zeolitic phase is absent in the control material synthesized in the absence of ZnO addition (0ZnO—Y—C, FIG. 5E) as well as in the parent CBV720 material (FIG. 5F). A similar extra phase after hydrothermal treatment and calcination is also observed at a lower ZnO content in the synthesis for 5ZnO—Y—C-135HT0.00-C and 10ZnO—Y—C-135HT0.00-C, indicating a common phenomenon of synthesizing non-zeolitic phase after hydrothermal treatment in the bulk ZnO-applied system with a ZnO amount range of 5-30 wt. %.

30ZnO—Y—C was chosen for further characterization because the obvious morphological nonuniformity in this material provides an opportunity to clearly observe the synthesis of large-scale mesoporosity, in a manner that is not blocked or obscured by the zeolite crystallites (inside of which large-scale mesoporosity is also being synthesized). The same changes that synthesize mesoporosity in this external phase should also occur inside of the zeolitic phase. This would then allow one to connect whatever is occurring outside of the zeolite crystallite, in the easily observable non-zeolitic phase, to what is occurring inside of the zeolite crystallite during large-mesopore synthesis. The non-zeolitic phase before and after hydrothermal treatment/calcination are then investigated with the understanding that the same processes that synthesize large mesopores also occur in the zeolitic phase. When comparing the non-zeolitic phase before (FIGS. 5A and 5B) and after (FIGS. 5C and 5D) hydrothermal treatment, one observes large mesopores on the surface of the non-zeolitic phase after hydrothermal treatment, which are absent before. The large mesopores were synthesized in the non-zeolitic phase.

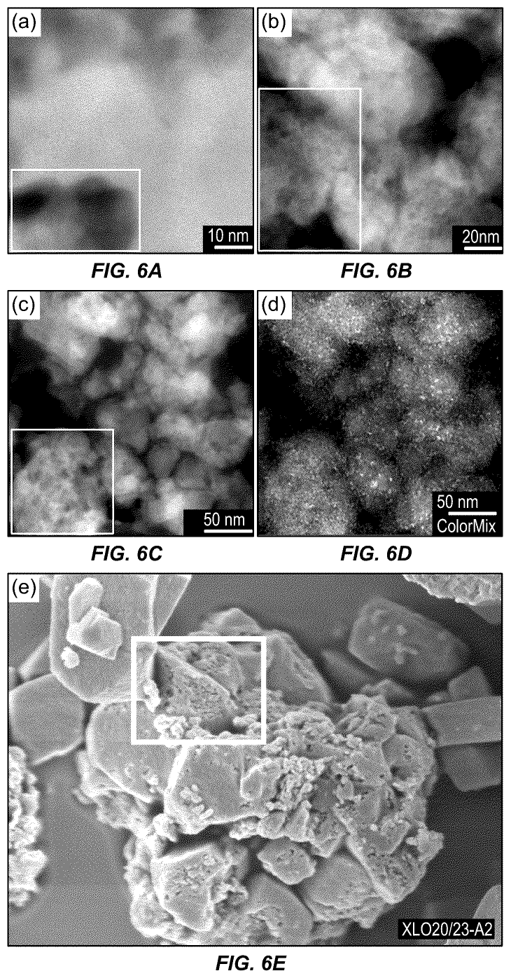

Evidence for the synthesis of these large mesopores also occurring in the zeolitic phase is described below. HAADF-STEM images of microtomed sections of 30ZnO—Y—C-135HT0.15-C in FIGS. 6A-6C demonstrate large mesopores in areas immediately adjacent to crystalline material in FIGS. 6A-6C, which show good spatial resolution and lack of electron beam damage to the crystalline structure of the zeolite particle. These images offer direct proof of synthesizing large mesopores in the interior of zeolite particles. FIG. 6D presents an elemental map from STEM-EDX of the same area as in FIG. 6C. At the nanoscale level, the ultramicrotomed 30ZnO—Y—C-135HT0.15-C clearly shows compositional homogeneity of Zn. These data demonstrate Zn penetration into the zeolite particles, which contain large mesopores after hydrothermal treatment. A rare glimpse of synthesized mesoporosity by SEM is shown on a broken zeolite crystallite of 30ZnO—Y—C-135HT0.15-C. The pits on the external surface of the broken zeolite particle in FIG. 6E correspond to large mesopores inside the zeolite particle.

### Example 10

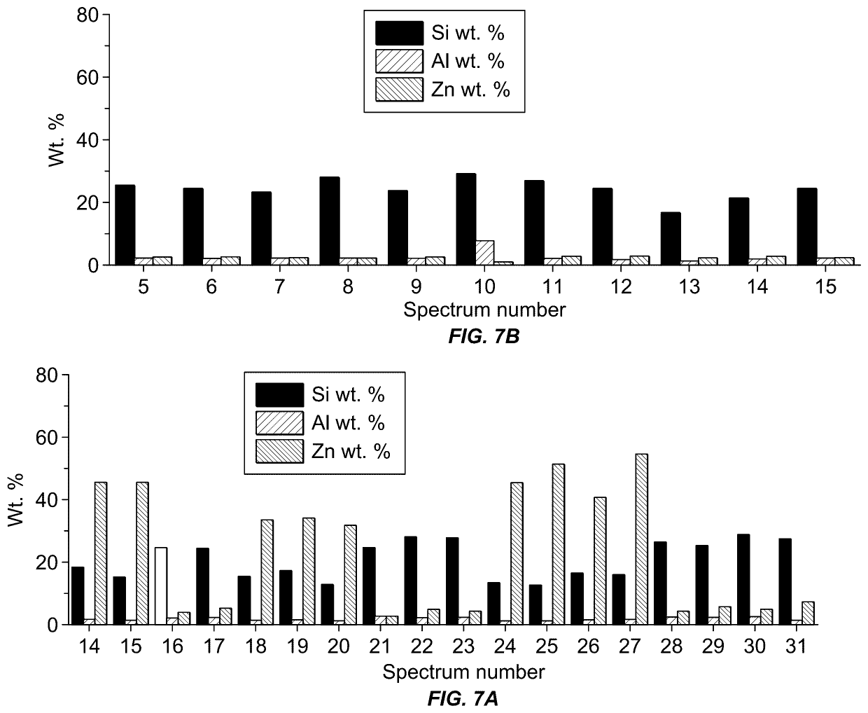

The composition and elemental distribution before and after hydrothermal treatment was investigated with 30ZnO—Y—C via SEM-EDX as shown in FIG. 7. Data in FIG. 7A demonstrate the compositions of the two phases described above in material 30ZnO—Y—C. Before hydrothermal treatment, the zeolitic phase is Zn-poor with an average Zn composition of 4.6 wt. %, and the non-zeolitic phase is Zn-rich with an average Zn composition of 42.3 wt. %, though both phases contain Si, Al, and Zn. Similar phase separation and compositional non-uniformity were observed for related materials prior to hydrothermal treatment and calcination, demonstrating the generality of this result. As described above, the corresponding material after hydrothermal treatment, 30ZnO—Y—C-135HT0.15-C, in FIG. 7B is compositionally uniform, with an average Zn composition of 2.2 wt. %. The calcination and following hydrothermal treatment allow zinc transport inside the zeolite crystals, uniformly throughout the material, where mesoporosity is synthesized.

### Example 11

A cleaner material, which consists of a single zeolitic phase, is synthesized, in which there are large mesopores. The approach is to decrease the morphological nonuniformity present in 30ZnO—Y—C by synthetic approaches that synthesize more uniform distributions of Zn prior to hydrothermal treatment. Underlying this approach is a hypothesis that the intrinsic phase separation observed before hydrothermal treatment in 30ZnO—Y—C is brought about by the separate ZnO phase (i.e. lack of molecular dispersion) introduced into the Meso-Y synthesis. It was hypothesized that a molecularly dispersed form of Zn could lead to the desired result by proceeding through an intermediate consisting of a chemisorbed ZnO layer on the zeolite surface. This approach is guided by previous successful post-synthetic synthesis of a uniform nanoscale coating of other oxides (consisting of silica and alumina) on the surface of Meso-Y crystallites, without blocking internal pores. Bis(2-ethoxyethoxy)zinc was first synthesized via procedures published in U.S. Pat. No. 4,751,318, followed by the synthesis shown in Scheme 2 (the calculated ZnO to as-made zeolite mass ratio was fixed at 9.3 wt. %).

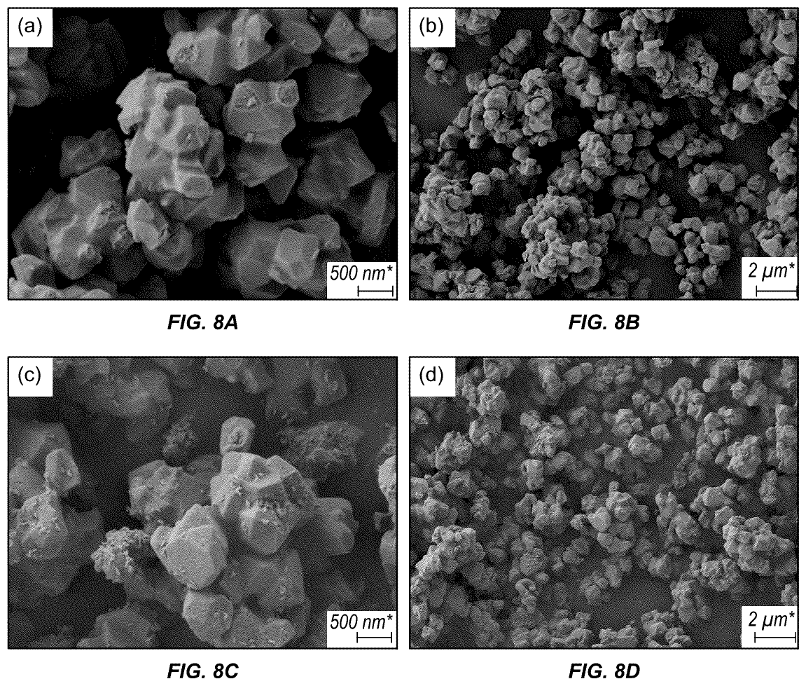

SEM images in FIGS. 8A and 8B show uniform morphology of 9.3ZnO (Zn alkoxide)-Y—C after molecular Zn coating and calcination, indicating a successful homogeneous phase synthesis before hydrothermal treatment. This is further confirmed by 9.3ZnO (Zn alkoxide)-Y—C, compared with the 0ZnO—Y—C, showing a slightly depressed isotherm, unchanged pore-size distribution, retained zeolite crystallinity, and a lower surface area. This morphological uniformity of 9.3ZnO (Zn alkoxide)-Y—C is in stark contrast to those in FIGS. 5A and 5B, where phase separation occurred after the calcination (before hydrothermal treatment).

### Example 12

Hydrothermal treatment of Zn alkoxide-reacted materials was investigated at various temperatures (100° C., 125° C., and 150° C.). An increase in the mesopore size representing the maximum in the pore-size distribution from 9.3 nm to 18.6 nm as well as a decrease in zeolite crystallinity was observed upon increasing the hydrothermal treatment temperature. This is consistent with results observed in the ZnO-derived system. The presence of a non-zeolitic phase is observed being synthesized at higher hydrothermal treatment temperatures, and this phase is particularly pronounced as a flaky morphology in materials synthesized at a 150° C. hydrothermal treatment temperature. In contrast, as shown in FIGS. 8C and 8D, the SEM images of the material hydrothermally treated at 100° C. exhibit a uniform morphology, which offers an opportunity to further investigate the location of large mesopores. Considering the large mesopore volume of 0.51 cm³/g of 9.3ZnO (Zn alkoxide)-Y—C-100HT0.00-C and a large mesopore size of 9.3 nm along with its uniform morphology, it appears that large mesopores must be localized inside zeolite particles, just as described above for the ZnO-derived materials. The major difference is that for the alkoxide-derived materials, as mentioned above, only a single zeolitic phase is evident via SEM. Physisorption results indicate that drying temperature under vacuum and the calcination duration before hydrothermal treatment show a minor effect on the mesopore size distribution and porosity.

### Example 13

The present example investigates whether post-synthetic reaction of the Meso-Y material with a simple inorganic Zn salt instead of the Zn alkoxide described above could be sufficient for synthesizing large mesopores, thereby obviating the need for laborious (extra steps) and costly alkoxide synthesis. Thus, the Zn alkoxide above was substituted with Zn(NO₃)₂ in the same molar amounts when conducting post-synthetic reaction of Meso-Y. Following hydrothermal treatment at 100° C., the resulting 9.3ZnO (Zn(NO₃)₂)—Y—C-100HT0.00-C) material shows nearly the same (less than 10% lower) mesopore volume, micropore volume (less than 10% higher), and the same mesopore size distribution (9.3 nm) compared with the Zn alkoxide-derived comparator material 9.3ZnO (Zn alkoxide)-Y—C-100HT0.00-C. Reacting Meso-Y with Zn(NO₃)₂ leads to essentially the same material as doing so with Zn alkoxide. Given the fewer steps involved in the former, it is clearly preferred.

### Example 14

Also investigated was the impact of starting with a Meso-Y material with larger mesopores. The question in particular was: what is the impact after reaction with Zn(NO₃)₂ followed by hydrothermal treatment, if one starts with larger mesopores. Is the effect additive when comparing conventional Meso-Y and the variant with larger mesopores before reaction with Zn(NO₃)₂. A Meso-Y material that possessed a 2.9 nm larger mesopore was compared to the conventional Meso-Y (0ZnO—Y—C) described above. This was achieved through the previously described non-covalent surfactant swelling approach. After reacting both Meso-Y materials with Zn(NO₃)₂, calcining, hydrothermally treating both materials at 100° C., and calcining again, a shifted pore size distribution for the final material corresponding to the non-covalently swollen Meso-Y relative to the conventional Meso-Y was observed, and the magnitude of this shift is nearly identical to the 2.9 nm headstart of the former as-made Meso-Y material. A headstart in the as-made Meso-Y material directly translates to the final material, in an additive fashion.

To replace the remaining extra-framework Zn²⁺ cations with acidic protons in the materials, all hydrothermally treated and calcined materials were washed with 0.1 M aqueous HNO₃ at 100° C. for 16 h. This acid wash led to the removal of extra-framework Zn species observed by ICP analysis, leading to a low nominal final Zn content of 0.65 wt. % and 0.29 wt. % for the bulk ZnO-derived acid-washed material (30ZnO—Y—C-135HT0.15-C-100HT0.10-C) and the corresponding Zn alkoxide-derived material (9.3ZnO (Zn alkoxide)-Y—C-150HT0.00-C-100HT0.10-C), respectively. This acid wash step also led to a significantly increased mesopore volume (up to 0.64 cm³/g) and larger mesopore diameter (up to 20 nm) for both the ZnO- and Zn alkoxide-derived materials. It appears that the increase in mesoporosity after the acid wash is the result of removing debris blocking pores during the final acid wash.

### Example 15

The acidity of Meso-Y materials consisting of large mesopores was investigated by conducting a deuteration exchange reaction involving deuterated benzene (the reaction leads to deuteration of silanol groups via a Bronsted-acid catalyzed reaction). Both of these acid-washed materials had measurable levels of OD density, corresponding to values of 54 μmol/g and 21 μmol/g, for the ZnO- and alkoxide-derived materials above, respectively. It appears the lower level of exchange observed for the alkoxide-derived material is the result of its higher hydrothermal treatment temperature of 150° C. versus 135° C. for the bulk ZnO-derived material, which leads to more zeolite framework destruction, as underlined by its lower micropore volume. Both the ZnO- and alkoxide-derived materials had considerably lower levels of Bronsted acidity compared to controls consisting of parent materials (H)0ZnO—Y—C and (H)CBV720, which exhibited OD densities of 120 μmol/g and 360 μmol/g, respectively.

Substitution of HCl instead of HNO₃ for the acid-wash step resulted in 9.3ZnO (Zn alkoxide)-Y—C-125HT0.00-C-100HT0.10(HCl)—C material, which had no detectable acidity. Chloride is a less favorable anion for acid wash compared to nitrate, and chloride coordination to Al sites may be responsible for this.

### Example 16

In an attempt to investigate whether there was remaining unexchanged Zn²⁺ content that was blocking Bronsted acid sites, an ammonium ion exchange following the acid wash step above was performed, leading to material 30ZnO—Y—C-135HT0.15-C-100HT0.10-C-IE. However, this material had a lower OD density than its predecessor 30ZnO—Y—C-135HT0.15-C-100HT0.10-C lacking this final ion exchange. A final ammonium ion exchange does not appear necessary.

In summary, a mechanism for large mesopore synthesis is provided. Scheme 3 illustrates the process. The mechanism involves a Zn species etching zeolite within the Meso-Y starting material. The driving force for this etching is the synthesis of a dense ZnAlSi material, which forms via condensation during calcination following reaction of Meso-Y with the Zn precursor, which is seen via SEM in syntheses involving bulk ZnO as the Zn precursor. When a molecularly dispersed Zn precursor (such as Zn(NO₃)₂ or Zn alkoxide) was used, this ZnAlSi phase was not observed outside of the zeolite particles via SEM. It appears that following hydrothermal treatment, the dense ZnAlSi phase rearranges to synthesize the observed large mesopores, which can be further enlarged by a final acid wash to remove residual Zn.

It has been found that reacting Zn post-synthetically under hydrothermal conditions with Meso-Y synthesizes large mesopores. In previous attempts of post-synthetic modification of Meso-Y under forcing conditions involving surfactant swelling via non-covalent interactions, the synthesis of larger mesopores was not achieved. This comparison highlights the power of an approach based on covalent-bond driving forces for large mesopore synthesis.

Large mesopores up to 20 nm or larger in diameter can be successfully synthesized in a Meso-Y zeolite by the present process. The process first etches the Meso-Y parent material with Zn during a hydrothermal treatment step that is preceded by calcination. The critical parameters for the synthesis of large mesopores are identified as (i) intimate contact between a zinc species such as ZnO and aluminosilicate via initial calcination, (ii) a residual amount of ZnO during a hydrothermal treatment, and (iii) preservation of the zeolite framework during subsequent hydrothermal treatment. Evidence of N₂ physisorption, SEM, HAADF, and STEM-EDX from ZnO-derived and/or molecular zinc-derived systems confirms the synthesis of large mesopores inside the zeolitic particles with uniform zinc distribution possible for the molecular systems. In the ZnO-derived system, phase separation occurred both before and after hydrothermal treatment, and large mesopores were synthesized in both non-zeolitic phase and the zeolitic phase. In one embodiment, the zinc species or precursor can comprise ZnO, an alkoxide such as bis(2-ethoxyethoxy)zinc or Zn(NO₃)₂.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present process and system, but they are not essential to its practice. It is therefore to be understood that the invention may be practiced otherwise than as specifically described without actually departing from the spirit and scope of the present invention as defined by the appended claims.

While various embodiments have been described for purposes of this disclosure, various change and modifications may be made which are well within the scope contemplated by the present disclosure. Numerous other changes may be made which will readily suggest themselves to those skilled in the art and which are encompassed in the spirit of the disclosure.

What is claimed is:

1. A process for preparing a large mesopore meso-Y zeolite comprising:
a) providing a parent meso-Y zeolite and calcining the zeolite together with a zinc species to produce a material with a zincoaluminosilicate phase; and
b) subjecting the material with a zincoaluminosilicate phase to a hydrothermal treatment in the presence of residual zinc species from a) to thereby produce a large mesopore meso-Y zeolite.

2. The process of claim 1, wherein the zinc species comprises ZnO, a zinc alkoxide or a zinc salt.

3. The process of claim 1, wherein the zinc species comprises ZnO.

4. The process of claim 2, wherein the zinc salt comprises Zn(NO₃)₂.

5. The process of claim 1, wherein the parent meso-Y zeolite is a meso-Y zeolite that has been treated with a surfactant.

6. The process of claim 5, wherein the parent meso-Y zeolite is a meso-Y zeolite that has been treated with a surfactant.

7. The process of claim 6, wherein the CTA surfactant comprises cetyltrimethylammoniumbromide (CTAB).

8. The process of claim 1, wherein the hydrothermal treatment comprises heating the material in an aqueous acid solution.

9. The process of claim 8, wherein the concentration of acid in the aqueous solution ranges from about 0.5 M to about 0.30 M.

10. The process of claim 9, wherein the acid concentration ranges from about 0.01 M to about 0.30 M.

11. The process of claim 9, wherein the acid concentration ranges from about 0.17 M to about 0.20 M.

12. The process of claim 1, wherein the amount of zinc species in step a) ranges from about 20 to about 40 wt. % based on the weight of the meso-Y zeolite.

13. The process of claim 12, wherein the amount of zinc species in step a) is about 30 wt. %.

14. The process of claim 1, wherein the large mesopore meso-Y zeolite produced in b) is recovered.

15. The process of claim 14, wherein the recovered large mesopore meso-Y zeolite has mesopores in the range of from 9-16 nm in diameter.

16. The process of claim 14, wherein the recovered large mesopore meso-Y zeolite has mesopores with a diameter in the range of about 20 nm.

17. The process of claim 14, wherein the recovered large mesopore meso-Y zeolite has a mesopore volume in the range of from about 0.45 to 0.70 cm³/g.

18. The process of claim 17, wherein the mesopore volume is above 0.64 cm³/g.

19. The process of claim 14, wherein the recovered large mesopore meso-Y zeolite is subjected to an acid wash.

20. The process of claim 19, wherein the acid wash is with aqueous HNO₃.

21. The process of claim 1, wherein the amount of residual zinc species in step b) ranges from about 1 to 25 wt. % of the material.

22. The process of claim 21, wherein the amount of residual zinc species in step b) ranges from about 5 to 20 wt. % of the material.

23. A large mesopore meso-Y-zeolite prepared by the process of claim 1.

24. A large mesopore meso-Y-zeolite prepared by the process of claim 19.
